(19) United States
(12) Patent Application Publication
(10) Pub. No.: US 2006/0117252 A1
(43) Pub. Date: Jun. 1, 2006

(54) Systems and methods for document analysis

(76) Inventors: Joseph Du, Hsinchu City (TW); Bing-Hung Lin, Xindian City (TW); Yueh-Ching Lee, Jhongli City (TW); Chun-Yi Chen, Hualien Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/999,047

(22) Filed: Nov. 29, 2004

(51) Int. Cl. G06F 17/21; G06F 7/00; G06F 17/30

(52) U.S. Cl. 715/514; 707/3; 707/7; 715/513; 715/500

(57) ABSTRACT

A system for document analysis. A library stores a plurality of technical terms and relationship indices specifying relationships therebetween. A parser extracts first and second object hierarchies from a first and second document, wherein the first and second object hierarchies comprise a plurality of first and second reference objects, respectively. A processor searches the library for technical terms corresponding to the first and second reference objects, and determines a relevancy rating therebetween according to the relationship indices corresponding to the located technical terms.

### BACKGROUND

The invention relates to document analysis, and more particularly to document relevancy analysis.

In conventional document analysis, a technical document such as a patent document is compared with other technical documents by a user. The user reads the documents, analyzes contents thereof, and draws diagrams to deduce the relationships therebetween. The conventional method is time-consuming and mistake-prone. Additionally, since the comparison result is based largely on subjective opinion, different results can be obtained by different users.

Another conventional technique categorizes the document according to categorized information contained therein. For example, patent documents are categorized based on parameters such as assignee, inventor, and country. The analysis may be implemented based on information not relevant to the essence of the analyzed patent documents.

### SUMMARY

Systems for document analysis are provided. In embodiments of a document analysis system comprising a library, parser, and processor, the library stores a plurality of technical terms and relationship indices specifying relationships therebetween. The parser extracts first and second object hierarchies from a first and second document, wherein the first and second object hierarchies comprise a plurality of first and second reference objects, respectively. The processor searches the library for technical terms matching the first and second reference objects, and determines a relevancy rating therebetween according to the relationship indices corresponding to the located technical terms.

Also disclosed are methods of document analysis. In an embodiment of such a method, a library comprising a plurality of technical terms and relationship indices specifying relationships therebetween are provided. First and second documents are provided, and corresponding first and second object hierarchies are extracted from the first and second documents, wherein the first and second object hierarchies comprise a plurality of first and second reference objects, respectively. The library is searched for technical terms matching the first and second reference objects, and a relevancy rating therebetween is determined according to the relationship indices corresponding to the technical terms.

Various methods may take the form of program code embodied in a tangible media. When the program code is loaded into and executed by a machine, the machine becomes an apparatus for practicing the invention.

### DESCRIPTION OF THE DRAWINGS

The invention can be more fully understood by reading the subsequent detailed description and examples with references made to the accompanying drawings, wherein:

FIG. 1 is a schematic view of an embodiment of a system for document analysis;

FIG. 2 is a flowchart of an embodiment of a document analysis method;

FIG. 3 is a schematic view showing an embodiment of a multidimensional space of technical terms; and

FIG. 4 is a diagram of a storage medium storing a computer program providing an embodiment of a document analysis method.

### DETAILED DESCRIPTION

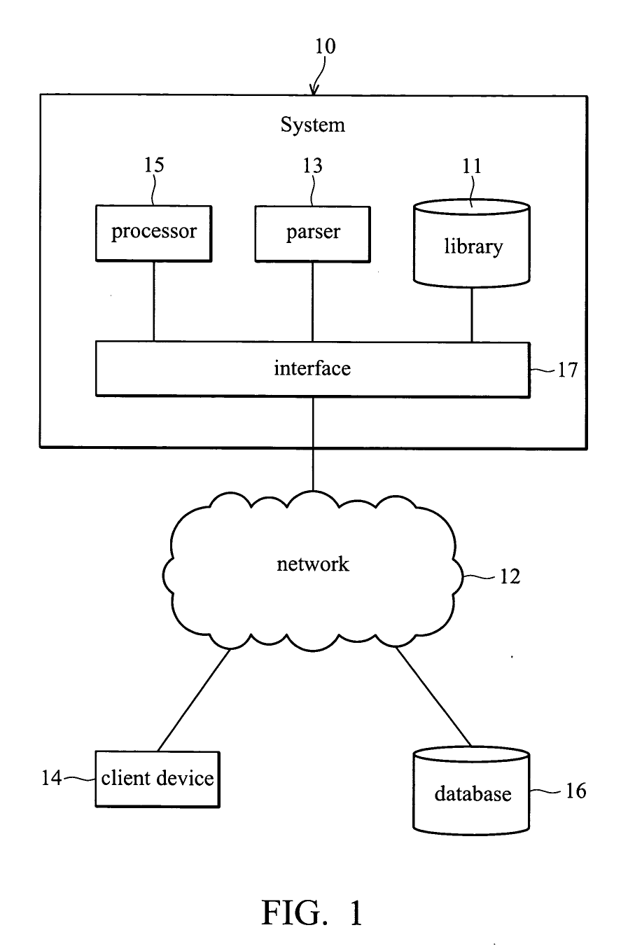

Exemplary embodiments of the invention will now be described with reference to FIGS. 1 through 4, applied to here patent document analysis. While some embodiments of the invention are applied with two patent documents, it is understood that the document analyzed by the system is not critical, and other documents with embedded a object hierarchy may be readily substituted.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a system for document analysis. Specifically, system 10 compares a first document and a second document, and determines relevancy therebetween. System 10 comprises a library 11, parser 13, and processor 15. The library 11 stores a plurality of technical terms and relationship indices specifying relationships therebetween. The technical terms may be arranged in different ways. For example, technical terms of the same technical field may be grouped together, wherein technical terms pertaining to a particular concept are allocated within one “dimension”. When the first document is to be compared with the second document, both are sent to system 10 through a network 12. The second document may be a patent document, engineering report, or journal article, retrieved from a database 16. The first document may be a patent document provided by a client device 14. The first document and the second document are received through interface 17, and relayed to parser 13 for further analysis.

The parser 13 parses the first document and extracts an object hierarchy therefrom comprising a plurality of reference objects. The object hierarchy is derived mainly from a predetermined field of the first document, comprising branches of an object hierarchy, with further nested nodes therein. Each reference object of the first document is associated with a weighting factor. Similarly, parser 13 parses the second document and extracts an object hierarchy therefrom comprising a plurality of reference objects.

The described object hierarchies are sent to the processor 15 for further processing. The processor 15 searches the library 11 for technical terms matching the reference objects of the patent and technical documents, and determines a relevancy rating therebetween according to the relationship indices corresponding to the technical terms. The processor 15 determines a relevancy score of the reference object according to the relationship indices of the corresponding technical terms, and multiplies the relevancy score by the weighting factor to obtain a weighted relevancy score of the reference object. The processor 15 determines the relevancy rating between the first and second documents by summing the weighted relevancy scores of reference objects thereof. Information pertaining to the relevancy rating is then transmitted to the client device 14 through network 12.

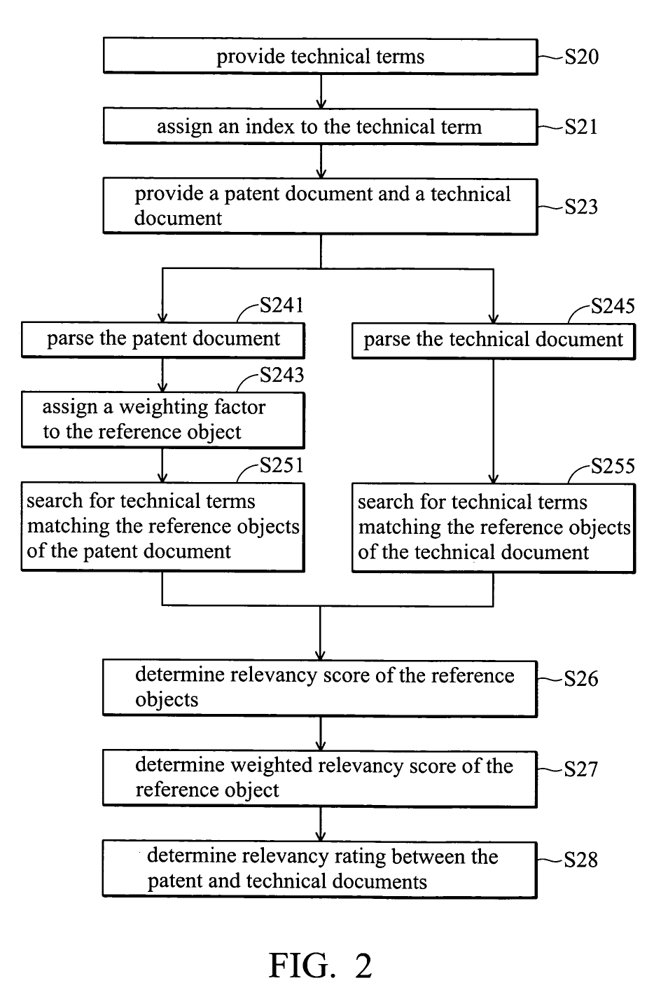

The processing algorithm implemented in system 10 is detailed in the flowchart of FIG. 2. A plurality of technical terms pertaining to a particular technical field are provided (step S20). For example, technical terms pertaining to semiconductor manufacturing may be provided, arranged in a network structure. The network may be situated in a multidimensional space, wherein each dimension specifies a feature of a technical term. For example, if the network is situated in a three-dimensional space, dimensions thereof specifying features pertaining to process, equipment, and device of a particular term. The technical terms are arranged according to the technical meanings thereof.

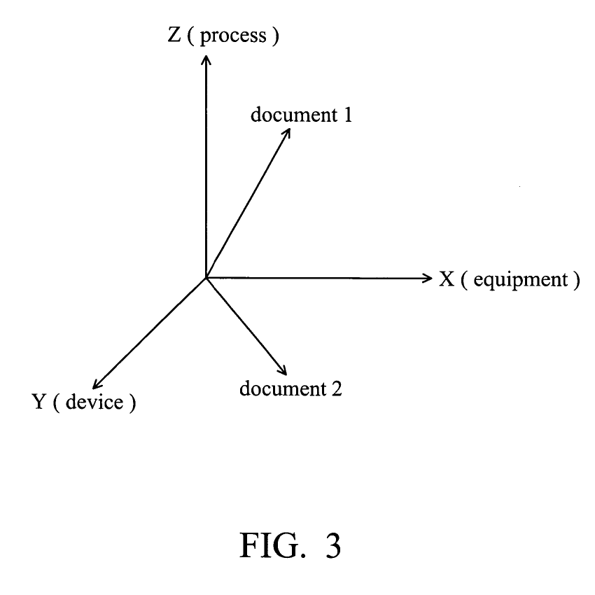

Technical terms of the same technical field are assigned an index in a corresponding dimension according to the technical meaning thereof (step S21). Each technical term can be identified using a vector (X,Y,Z), wherein X, Y, and Z correspond to indices of equipment, device, and process, respectively (as shown in FIG. 3). A relationship index specifying relationship between two technical terms is determined-by calculating the distance between the corresponding vectors in the space.

A first document and a second document are provided to be analyzed (step S23). The second document may be a patent document, engineering report, or journal article. The first document may be a patent document. The first document is parsed and object hierarchy is extracted therefrom, comprising a plurality of reference objects (step S241). In step S243, each of the reference objects is assigned a weighting factor indicating importance thereof. If the first document is, for example, a patent document, each independent claim and claims depending therefrom constitute branches and nested nodes of the object hierarchy. The second document is parsed similarly and an object hierarchy extracted therefrom, wherein the object hierarchy comprises a plurality of reference objects (step S245).

The library is searched for technical terms matching the reference objects of the first and second documents (steps S251 and S255). As described above, each technical term can be identified using a vector (X,Y,Z), wherein X, Y, and Z correspond to indices of equipment, device, and process, respectively. The object reference can be identified using the vector of the corresponding technical term. The relationship index specifying relationship between two technical terms can be determined by calculating the distance between the corresponding vectors in the space. Therefore, a relevancy score specifying relationship between the reference objects of the patent and technical documents can be determined in the same way. In step S26, the relevancy score of the reference objects is determined.

As described above, each reference object of the first document is assigned with a weighting factor according to its importance in the analysis. In step S27, the relevancy score is multiplied by the weighting factor to obtain a weighted relevancy score of the reference object. In step S28, the weighted relevancy score are added up to obtain a relevancy rating between the first and second documents. Reference objects extracted from different claims can be assigned different weighting factors, and the weighting factor of the claim combined into the calculation of the relevancy rating by multiplying the relevancy score summation of each reference object by the weighting factor and adds up the weighted relevancy score summation to generate the relevancy rating of the whole object hierarchy.

Various embodiments, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. Some embodiments may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing embodiments of the invention. When implemented on a general-purpose processor, the program code combines with the processor to provide a unique apparatus that operates analogously to specific logic circuits.

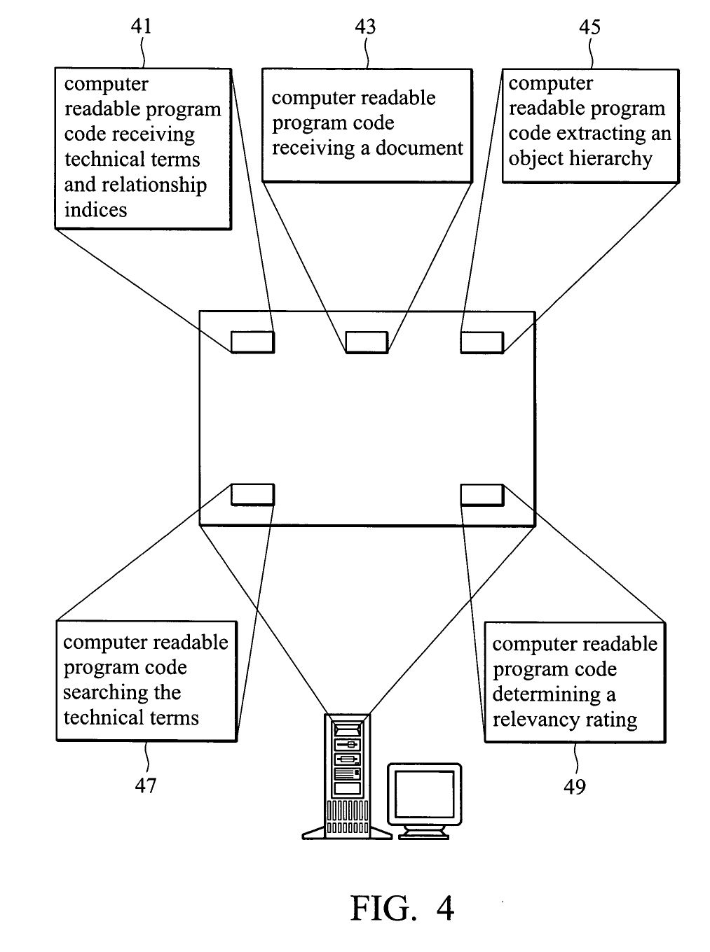

FIG. 4 shows a diagram of an embodiment of a system that includes storage medium storing a computer program implementing an embodiment of a document analysis method. The system comprises a computer-usable storage medium having computer-readable program code. Specifically, the code comprises computer-readable program code 41 receiving a plurality of technical terms and relationship indices specifying relationships therebetween, computer-readable program code 43 receiving a first document and a second document, computer-readable program code 45 extracting first and second object hierarchies from the first and second documents, computer-readable program code 47 searching the technical terms matching the first and second reference objects, and computer-readable program code 49 determining a relevancy rating therebetween according to the relationship indices corresponding to the technical terms.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A system for document analysis, comprising:
a library storing a plurality of technical terms and relationship indices specifying relationship therebetween;
a parser extracting first and second object hierarchies from first and second documents, wherein the first and second object hierarchies comprise a plurality of first and second reference objects, respectively; and
a processor searching the library for technical terms corresponding to the first and second reference objects, and determining a relevancy rating therebetween according to the relationship indices corresponding to the located technical terms.

2. The system of claim 1, wherein the first document is a patent document comprising a set of claims, each of which corresponds to a node in the first object hierarchy.

3. The system of claim 1, wherein the second document is a patent document, journal article, or technical document.

4. The system of claim 1, wherein the first reference object is associated with a weighting factor.

5. The system of claim 1, wherein the processor determines a relevancy score of the second reference object relating to the first reference object according to the relationship indices of the corresponding technical terms.

6. The system of claim 5, wherein the processor multiplies the relevancy score by corresponding weighting factor to obtain a weighted relevancy score of the second reference object.

7. The system of claim 6, wherein the processor determines the relevancy rating between the first and second documents by summing the weighted relevancy scores of reference objects thereof.

8. A method of document analysis, comprising:
providing a library comprising a plurality of technical terms and relationship indices specifying relationship therebetween;
providing a first document and a second document;
extracting first and second object hierarchies from the first and second documents, wherein the first and second object hierarchies comprise a plurality of first and second reference objects, respectively; and
searching the library for technical terms corresponding to the first and second reference objects, and determining a relevancy rating therebetween according to the relationship indices corresponding to the technical terms.

9. The method of claim 8, wherein the first document is a patent document comprising a set of claims, each of which corresponds to a node in the first object hierarchy.

10. The method of claim 8, wherein the second document is a patent document, journal article, or technical document.

11. A method of claim 8, further comprising assigning a weighting factor to each of the first reference objects.

12. The method of claim 8, further comprising determining a relevancy score of the second reference object relating to the first reference object according to the relationship indices of the corresponding technical terms.

13. The method of claim 12, further comprising multiplying the relevancy score by the weighting factor to obtain a weighted relevancy score of the second reference object.

14. The method of claim 13, further comprising determining the relevancy rating between the first and second documents by summing the weighted relevancy scores of reference objects thereof.

15. A computer readable storage medium storing a computer program providing a method of document analysis, comprising:
receiving a plurality of technical terms and relationship indices specifying relationship therebetween;
receiving a first document and a second document;
extracting first and second object hierarchies from the first and second documents, wherein the first and second object hierarchies comprise a plurality of first and second reference objects, respectively;
searching the technical terms corresponding to the first and second reference objects; and
determining a relevancy rating therebetween according to the relationship indices corresponding to the technical terms.

16. The storage medium of claim 15, wherein the first document is a patent document comprising a set of claims, each of which corresponds to a node in the first object hierarchy.

17. The storage medium of claim 15, wherein the method further comprises assigning a weighting factor to each of the first reference objects.

18. The storage medium of claim 15, wherein the method further comprises determining a relevancy score of the second reference object relating to the first reference object according to the relationship indices of the corresponding technical terms.

19. The storage medium of claim 15, wherein the method further comprises multiplying the relevancy score by the weighting factor to obtain a weighted relevancy score of the second reference object.

20. The storage medium of claim 15, wherein the method further comprises determining the relevancy rating between the first and second documents by summating the weighted relevancy scores of reference objects thereof.

21. The storage medium of claim 15, wherein the first and second documents are a patent document, journal article, or technical document, respectively.
